(19) United States
(12) Patent Application Publication
(10) Pub. No.: US 2011/0078036 A1
(43) Pub. Date: Mar. 31, 2011

(54) Systems and methods for the assessment, protection, marketing and commercialization of technology-based ideas

(75) Inventors: Brian Cummings, Salt Lake City, UT (US); Moj Eram, Deer Mountain, UT (US)

(73) Assignee: University of Utah Research Foundation, Salt Lake City, UT (US)

(21) Appl. No.: 12/807,636

(22) Filed: Sep. 10, 2010

Related U.S. Application Data
(60) Provisional application No. 61/276,395, filed on Sep. 11, 2009.

(51) Int. Cl. G06Q 99/00; G06Q 30/00; G06Q 10/00

(52) U.S. Cl. 705/26.3; 705/1.1

(57) ABSTRACT

The operations, methods and functions of a technology-based idea assessment, protection and connection system are described. The system involves new methods and computer based algorithms and networks to value technology based ideas, complete a quality assessment of the technology-based idea, package the technology-based idea and determine a cost-based strategy for protection of technology-based idea. The software-as-a-service system determines an output of an idea generator's strength in his technology or research network and suggests a path to commercialization. A protected technology-based idea is matched with a product development outlet such as a company, entrepreneur or executive manager to produce a faster commercialization outlet. The services and tools for the creation of technology-based start-ups are described. The system streamlines the costly and complicated process of technology commercialization by automatically aligning human and financial resources.

### RELATED APPLICATION

This application claims the benefit of U.S. Provisional Patent Application Ser. No. 61/276,395, filed Sep. 11, 2009, and entitled “Method of Automated Technology Commercialization” which is hereby incorporated by reference.

### BACKGROUND

1. Field of the Invention

The invention relates to technology commercialization software as a service. Specifically, the invention relates to the assessment of technology-based ideas, technologies and intellectual property and matches them with successful service providers, industry experts and entrepreneurs to provide the shortest path to commercialization and revenue generation for a given idea.

2. Background of the Invention

The software as a service system attempts to expedite the monetization of technology-based ideas and create the shortest path to revenue. The system and methods brings together a database of executive and industry talents and matches them to a relevant technology. The assessment of technology-based ideas is a complex and expensive process that leads to massive waste in patent budgets and gross inefficiencies in the attempt to translate research to products. At the same time the focus on technology based economic development has been ineffective due to competing programs and a misalignment of the key individuals that are needed to value early stage technology-based ideas, fund companies, structure product development and recruit and incentivize the needed entrepreneurial talent.

America's global economic competitiveness is based on the quality of its ideas and their deployment to achieve world-leading productivity in technology sectors driven by innovation. The nation's single largest investment in innovation is research funding granted to its research universities. This is in turn supplemented by state investments in colleges and universities with the potential to make major contributions to state economic growth and job creation. Each year there are approximately 180,000 new U.S. patents issued; whereas only 15-20% of them are used by the original developer, leaving about 150,000 patents to be sold or licensed annually. In total, there are potentially more than 1 million issued patents that are wasted. It is primarily the responsibility of the approximately 2000 university-based technology commercialization offices and corporate licensing departments to monetize these assets. With a total estimated value of all US intellectual property estimated to be $5 Trillion, there are massive inefficiencies in this system. In addition, the federal government spends over $50 Billion each year to create breakthrough research and science with little or no commercial outlets for this research. With an estimated 70% of all the University patents remaining unlicensed and an average of only 2.8 startup companies are produced per year per university, a strong need exists for a an automated system to expedite the evaluation of new technology-based ideas and shorten the path to commercialization. U.S. Universities conduct greater than ⅔ of all basic research, and are thus the primary source of technologies that produce over 400 startup companies per year. On the other hand, entrepreneurs, companies, and investors find it very difficult to engage universities in development of these innovations into scalable companies that have a sustainable impact on the economy in the form of new jobs created and increased taxable revenue.

The invention attempts to create a comprehensive database that can expedite economic development at the International level also. The Romain study showed that technological strength of a country's investment in US patents was a significant predictor of increased venture capital (VC) investment per country. By making US patents accessible, valued and packaged in unique marketing format their countries can participate in innovation and knowledge transfer. The Guier study showed that a one standard deviation increase in a nation's investment in U.S. patents caused a 78% increase in US venture dollars flowing into that country; and that a one standard deviation increase in scientific publications correlated to a 113% increase in venture capital investment. Further highlighting the value of university startups, 68% of those created between 1980-2000 remained in business in 2001, while regular startups experienced a 90% failure rate during that same period. In 2008, the latest data available from the Association of University Technology Managers (AUTM), 623 companies were formed by the 220 institutional members reporting data. These institutions report a total of $55.2 billion in 2008 research funding. At $88.6 million in research funding per start-up, the yield on the federal research investment was far less than might be expected. Seventy seven universities report no start-ups based on technologies developed with a collective $4.2 billion of federal funding and total research funding of $7.3 billion. Accordingly, a need exists to create a proprietary assessment, matching and exploitation model for the commercialization of new technology based ideas.

### SUMMARY OF THE INVENTION

The invention relates to an automated system to assess technology-based ideas, IP and companies in a computer based system of proprietary databases and user access. The relevancy of a technology-based idea and the idea's generator is calculated by a series of algorithms and a numerical output is generated that compares it to other technology-based ideas and technologies in the system and US and European patent databases. The idea generator's strength in his area of expertise and his connection strength in his respective network is also calculated and represented by a graphical output. Technology-based Ideas are then matched through a parsing algorithm that identifies and notifies relevant reviewers of their ability to further assess a technology-based idea. The user has the ability to select, or not, an idea generator that has conflict as part of their closed reviewer network. Another numerical output is generated from this closed network and combined with the automated relevancy output. This combined numerical output is assigned to a technology-based idea and a commercialization path can be suggested based on its value, market, strength of the intellectual property, competition, art, and strength of the user. If the technology-based idea or intellectual property is scored below a minimum threshold it can take a path of cost recovery commercialization, donation to a non-profit or humanitarian database or it feedback can be supplied by the idea generator for re submission back through the system. A non-confidential summary (NCS) and description of all technology-based ideas, input into the system, is automatically generated by the parsing algorithms based on user input fields. These NCS's are then stored in database and can be searched and accessed by user log in. Idea consumers such as venture capitalists, companies, CEO's, entrepreneurs, and non-profits can log into the system with a unique ID and password and can search all existing technology-based ideas and IP for a suitable technology match. If a match is made or statement of interest is indicated by an idea consumer, then the parties enter in an online contract and the technology proceeds down a series of semi automated commercialization steps. This automated process is comprised of generating a: Confidential Disclosure Agreement (CDA), Non Disclosure Agreement (NDA), NCS, Term sheet, technology valuation, license negotiation, and milestones toward product development. The process also monitors compliance, and search results for executive recruitment and funding.

A technology-based idea that scores above a minimum threshold is then assessed for legal protection based on a user survey. The legal protection may take the form of a copyright, trade secret, patent, tangible property, open source, or know-how and automated summary is posted for in-system service providers to review. The service providers complete a computer survey to identify key expertise, fee structures and services available to other users and an automated summary sheet is posted for review on the system. The process of protection of a technology-based idea is finalized through a series of preset forms and contracts between the designated idea generator and service provider. A cost assessment and IP budgeting tool is built into the system to track savings through the system and compared with national and average legal costs. A savings tracking algorithm monitors and displays these cumulative cost savings and can be used for further analysis of commercialization outcomes such as legal cost per start-up or license.

Once the technology-based idea is afforded legal protection, a further commercialization path is recommended with a bias toward starting a new technology based company. The protected technology-based idea is matched to a potential non-conflicted CEO or executive candidate or specific capital funding source unique to the system. A new company proceeds to a verification and certification tool that forces the idea consumer to work through a series of training and business exercises that ensure that any idea or business opportunity is well thought out and a customer need is met. This Nail-it-Scale it certification is a precursor to any funding needs that a company is requesting. Preference will be given to entrepreneurs and companies that are certified in this on-line education tool. A system and process for funding start-ups is embedded in this invention. The idea consumer must submit an on-line application for possible funding and the application is pre-screened and screened by a secure closed network. An idea generator can secure a contractual relationship with an idea generator at any time in the system. This process is comprised of an automated, CDA, NDA, NCS, Term sheet, technology valuation, license negotiation, on-line milestones toward product development, executive search and match for a CEO or relevant manager and capitalization.

Disclosed herein are methods and computer systems to assess technology-based ideas based on the prioritized strength of a technology-based idea and the idea's generator in a relative network with said method comprising obtaining a technology-based idea via a secure data input device to parse and separate out a technology-based ideas' specific attributes, features, novelty, art and consumer need; gathering specific information from the input fields to create an automated output of the summary of a technology-based idea that can serve as a marketing tool; controlling the validity of the input information and providing feedback; generating a numerical output of a technology-based idea's value and strength against other similar or unrelated technology-based ideas using networked databases; surveying individuals, researchers, and business professionals for relevant information; and generating an automated output of recommended non-conflicted reviewers for a technology-based idea to review and assess a technology-based idea; maintaining a database of technology-based ideas, idea generators and professionals. These methods disclosed herein can further provide a graphical representation of an individual's strength in their network of expertise, create a match between an individual or company with a relevant technology comprising a search that separates out conflicted individuals based on a personal survey and prior art, and/or generate a trusted group of reviewers in a confidential network to provide feedback, assessment and support for commercialization of a matched or unmatched technology-based idea. The disclosed methods can also create an automated incentive system for reviewers to receive monetary remuneration and points to participate in a long term reward system. The disclosed methods can also generate a recommended path to commercialization and subsequent steps in the semi-automated process. The disclosed methods can also use or utilize a computer, to protect technologies, technology-based ideas and intellectual property such as patents, trademarks, trade secrets, software, source code, patents and copyrights comprising surveying service providers to gather expertise and fixed fee structures for online services; generating an output the matches a technology-based idea or a technology with a service provider; generating a automated contract to establish a strategic relationship between service provider and technology or intellectual property.

Also disclosed herein are computer tracking algorithms that monitors and summarizes legal costs savings based upon an automated analysis of budgets, reimbursements and approved purchases.

The disclosed methods and computer systems can result results in a lower ranked technology-based idea, patent or IP needing an outlet other than a value based license or new start-up company. Also disclosed are methods and computer systems that create, provide and maintain a database and channels to donate, auction, trade and pool intellectual property comprising generating a computer output of related technologies, companies or individuals that have relevance to, creating a listing service or graphical diagram that targets companies and individuals in a network, conducting on-line transactions for sale, trade or donation to an entity, party, company, non-profit or government.

Also disclosed herein are user interfaces that allow customizable searches and searching for technology matched to an individual or company survey based on the individual or company's needs, technical expertise or business experience. The methods disclosed herein can also result in a new start-up company being formed from a technology, technology-based idea or IP from a network database comprising creation of a new company by filing, using an automated system, articles of incorporation, and relevant corporate documents, creating a needs assessment and product development plan for start-ups based on stage of technology, capital needs, industry segment, competition, and executive team, providing funding for early stage companies by providing access to internal and external funding sources, aligning all the necessary stakeholders that are required for the success of a start-up company in a trusted network so they are accessible and assigned team objectives, structuring and negotiating terms for licenses and capitalization based on pre-set templates, providing a suite of services that are necessary for a start-up to maximize return on investment, a corporate exit system that tracks the valuation and monetization of equity and distributes it to shareholders and reviewers involved in the assessment and commercialization of the associated technology or technology-based idea.

Also disclosed herein are business process methods that automates and shortens the path from the generation and protection of a technology-based idea to the creation of a new company, that trains a user in the process of nailing and scaling a technology-based idea in which a customer is identified and an unmet need is being met based on the technology-based idea that is being commercialized and validated. The process provides management and entrepreneurial talent and matches talent with a technology from a comprehensive idea consumer database that is maintained on internal servers, and/or that creates a compliance system for monitoring licensees and creating automated contracts with service providers.

### BRIEF DESCRIPTION OF THE DRAWINGS

FIG. 1: Represents the high level computer architecture that comprises the automated system of databases and servers. A secure user interface, via personal computers, in the cloud, is shown with a unique access for different users, idea generators, idea consumers and service providers. All technology-based data is accessed in the cloud and stored on external servers.

FIG. 2: Maps out the process for the assessment of technology-based ideas and IP and the output for relevancy scoring. When a new technology-based idea or existing piece of IP is entered into the system via a secure form, the technology-based idea is parsed into separate fields based on user input. The technology-based idea is ranked based on existing IP, market, stage of technology, strength of user in his field of expertise and competition. A technology-based idea is then matched to a network of experts and further valued via a closed network of reviewers that produce a further numerical assessment. The highest ranking technology-based ideas proceed to an exploitation and commercialization system.

FIG. 3: Outlines the exploitation phase in the automated system to commercialize technology-based ideas and IP. Once a technology-based idea has been ranked it is subject to various commercialization and monetization outlets including: donation, auction, cost recovery, fee based license or a new start-up company. The start-up processes are further detailed such that a new company or idea consumer can be educated and certified via the Nail-it-Scale it process and key executives and entrepreneurial talent can be targeted by a technology—consumer matching service.

FIG. 4: Illustrates the log in process for a new and existing user. A user may enter a new technology-based idea (1) into the system or search existing technology-based ideas, IP or companies (2) to engage in commercialization activities. The system separates, stores and maintains data, forms and technologies and matches in distinct databases.

FIG. 5: Illustrates a graphical output of an idea generator in his network of influence and shows the shortest path to connect to another individual.

FIG. 6: Outlines the steps in the Nail-it, Scale-it process.

FIG. 7: Represents the automated steps in the path from the assessment of a technology-based idea to the ultimate licensing or creation of a new start-up. The legal phase, services and business tools are also staged.

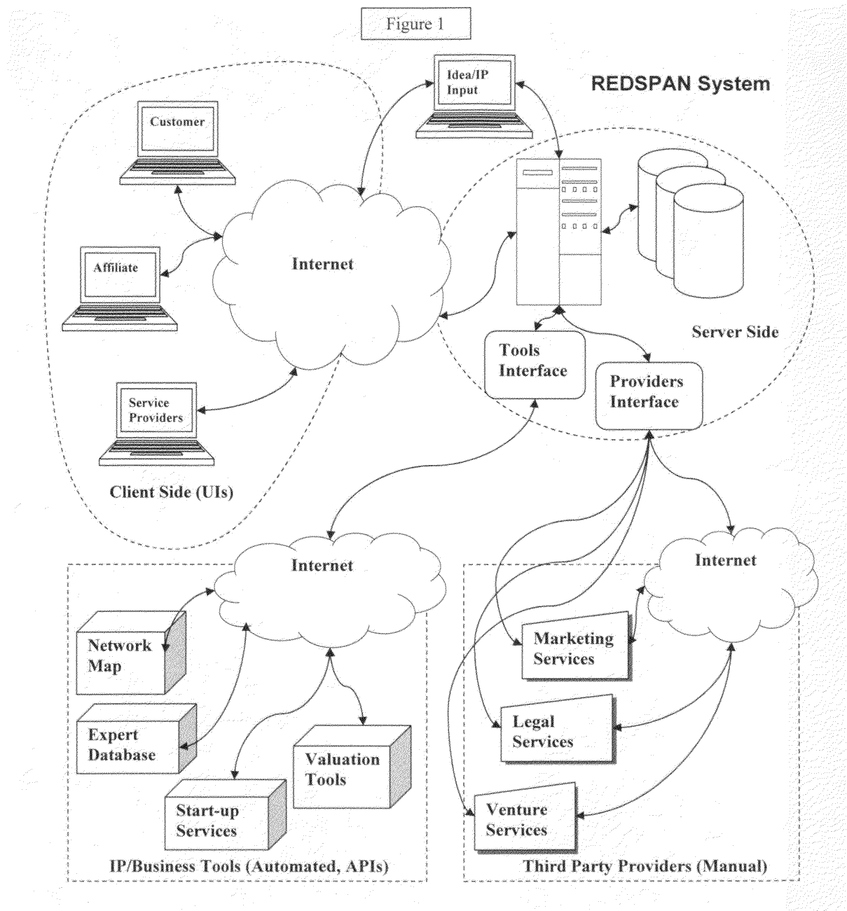

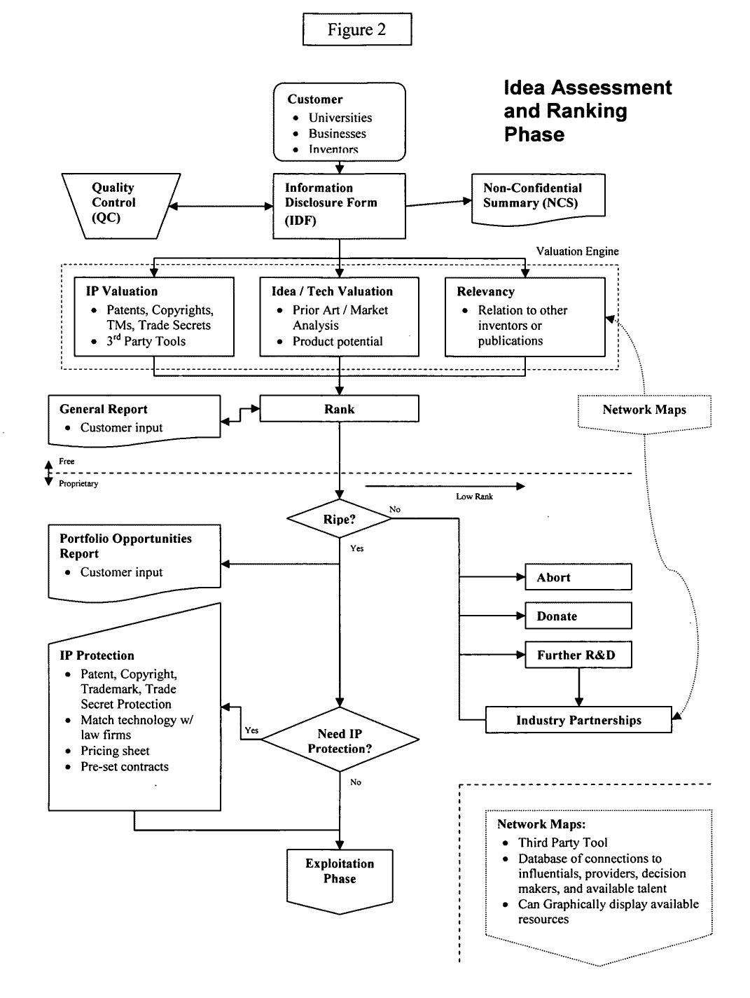

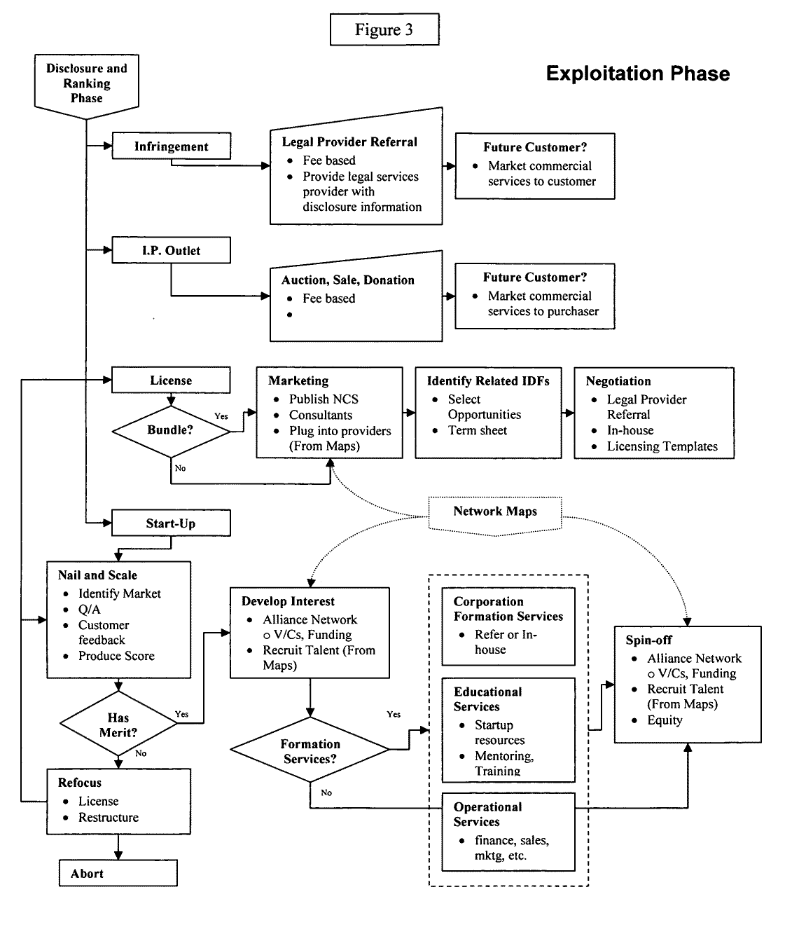

### DETAILED DESCRIPTION

The invention relates to the functions and operations of an automated technology commercialization service and technology matching service with a focus on the creation of viable start-ups as a commercialization outlet. A user is logged into the secure system using a computer or mobile networked device whereby the user is entering the system to either: (1) enter a new technology-based idea or technology-based business idea or (2) re-enter the system to track, update or engage an existing technology-based idea. A technology-based idea can be any idea that relates to or incorporates the usage and knowledge of tools, techniques, crafts, systems or methods of organization. A technology-based business idea is any idea that incorporates a technology-based idea into an organization designed to provide goods or services, or both, to consumers, businesses and/or governmental entities. The word “or” as used herein means any one member of a particular list and also includes any combination of members of that list.

The disclosed methods and systems can incorporate a relative network. A relative network can be one or more persons who have a specific area of expertise that relates to the technology-based idea generated by an idea generator. An idea generator can be any person or persons who conceive of identify a technology-based idea individually or as a group. A relative network can include one or more idea generators as well as one or more idea consumers. An idea consumer can also be an idea generator or any person or persons who analyze, develop, build, construct, research, market, fund, structure, and/or exploit a technology-based idea.

In one embodiment of the invention a unique technology-based idea or invention is input into a detailed, customized, online questionnaire that parses the idea into its key components via a computer or mobile system. Key fields of the technology-based idea are further parsed into key words and the key words are matched against existing databases to generate a relevant score based on: the maturity of the technology-based idea, the market for the technology-based idea, the competition currently in place, the prior art that exists, and the relevant strength of the idea generator. The idea generator's strength is based on the number of publications, citations and his connections in a technology, industry or research network. A graphical output of the individual and their connections is displayed; with a visual representation of his network and non-network individuals that have expertise in the technology area of interest.

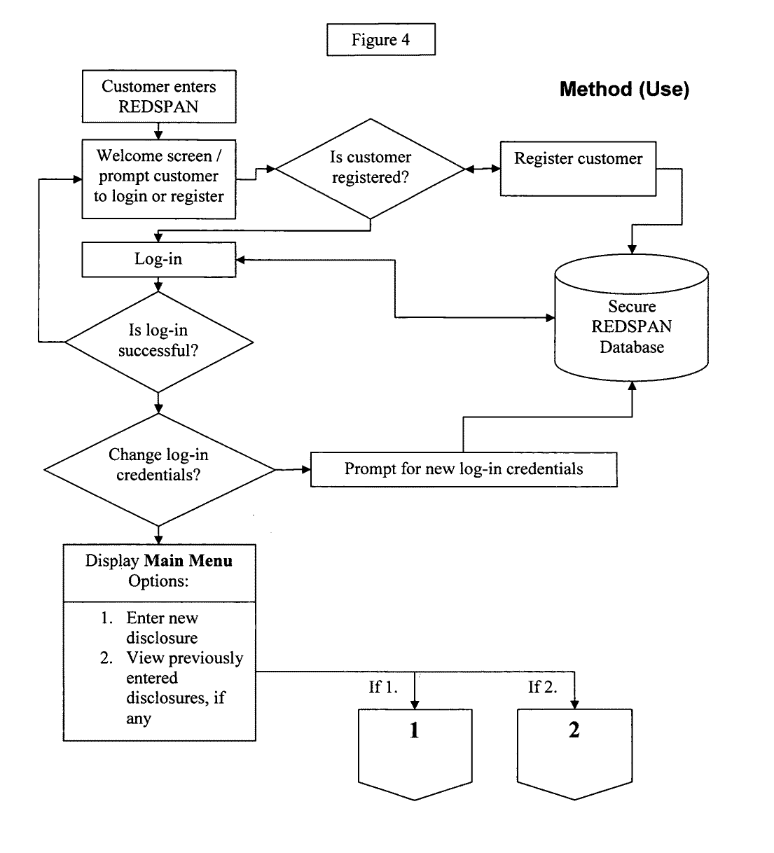

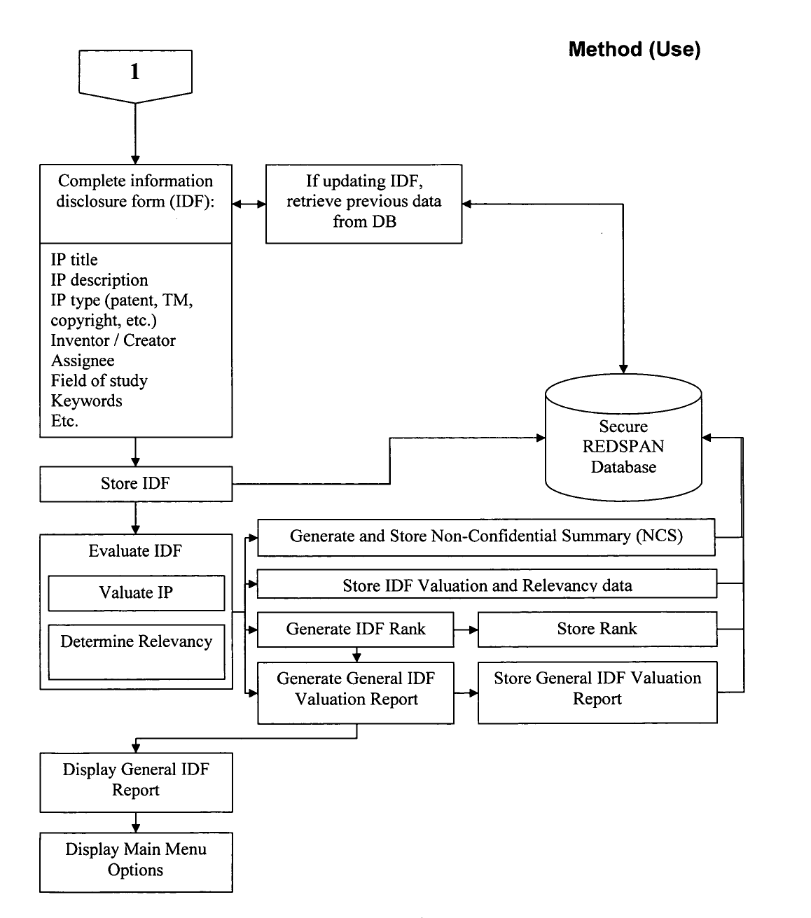

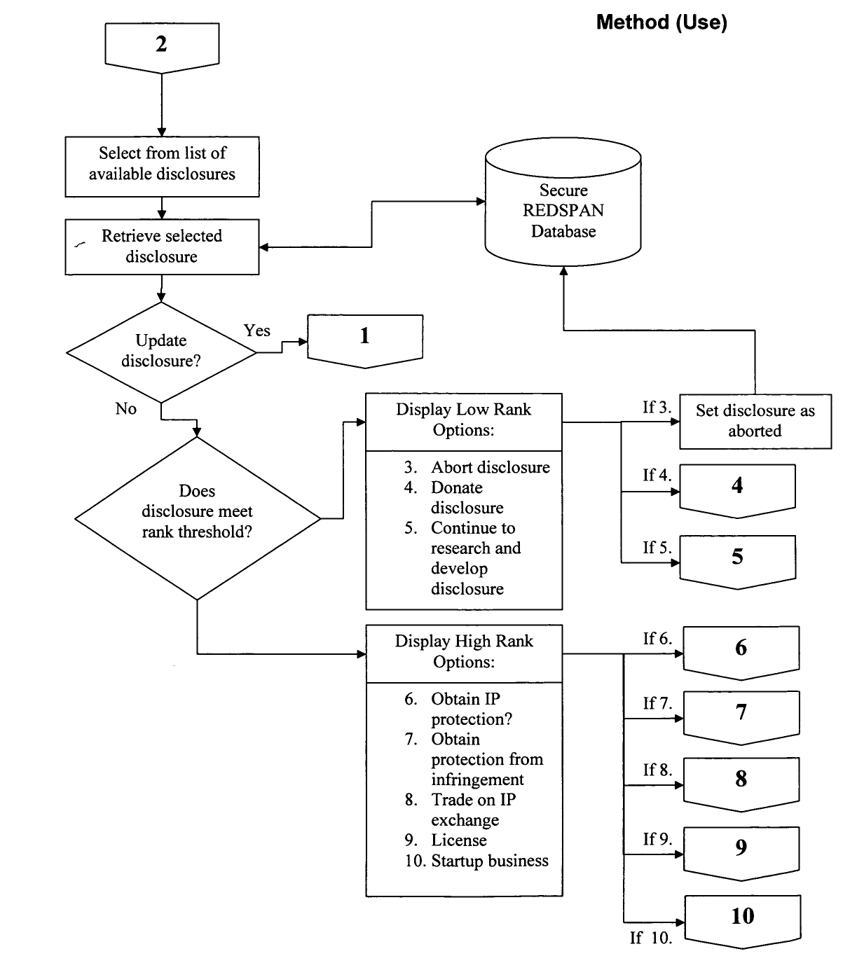

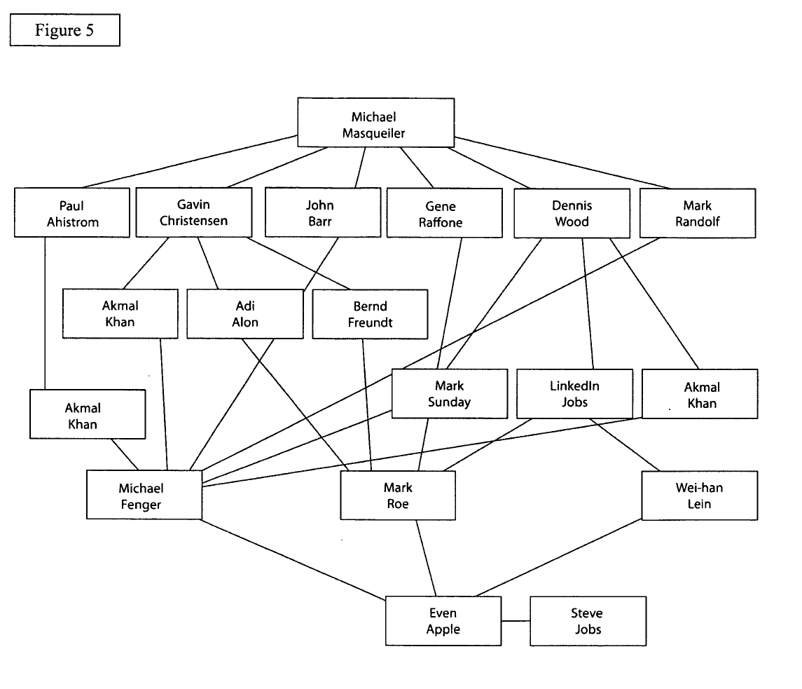

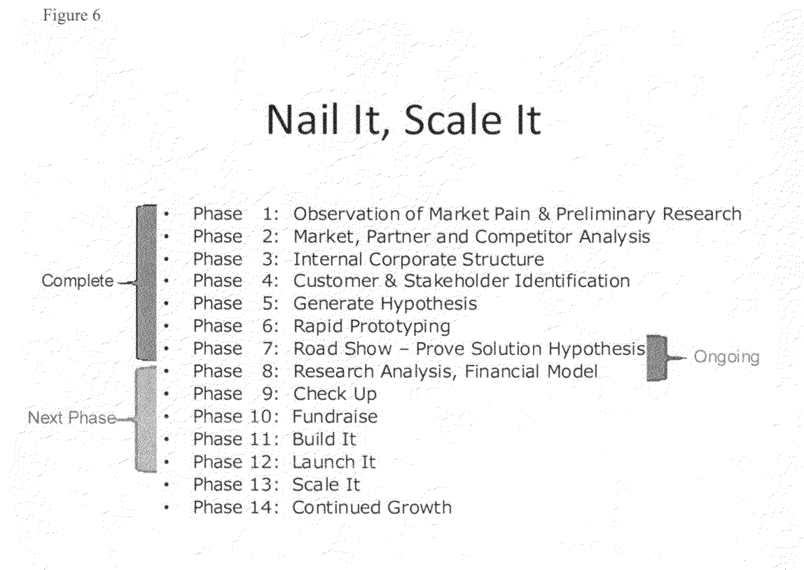

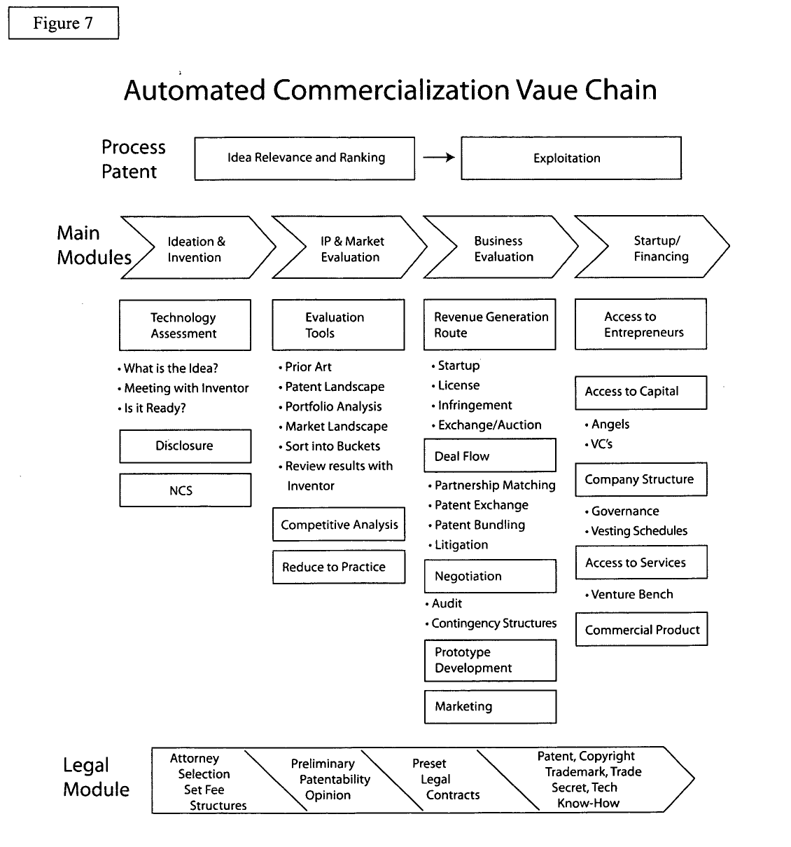

A numerical output is then generated that indicates the relevance of the technology-based idea generator and the relevance of the technology-based idea as to the technology-based idea's commercial potential. The technology-based idea is further segmented, using a computer algorithm, and matched with specific technology or business experts that have the ability to assess the value of the commercial potential of the technology-based idea. The technical experts are automatically invited to a closed network to complete an online evaluation of the technology-based idea and a subsequent numerical output is generated. A final numerical output is generated and a non-confidential summary of the technology-based idea is generated and placed into a separate database that tracks new and existing technology-based ideas and technologies (FIG. 4). A database of new unprotected technology-based ideas and existing legally-protected technology-based ideas is maintained. Technology-based Ideas and databases are categorized by type of IP (copyright, software, patent, pending patent, trade secret, know-how,) technology, industry, businesses, and numerical advancement in the commercialization process. The lowest ranked technology-based ideas are automatically parsed out and a cost recovery (if protected IP) or cost savings path is determined so no further legal costs would be incurred on a poorly valued or ranked idea. The cost recovery path leads to automated commerce modules whereby pre-set pricing structures, forms and contracts allow for the idea generators to recover legal costs, capture minimal value or donate a technology-based idea to a non-profit or humanitarian cause. The idea generator selects a predefined value for his technology-based idea and it is matched using the service listed below.

In another embodiment of the invention the technology matching service utilizes empirical data gathered from survey information from idea generators and idea consumers. The consumer may be an individual, company, not-for-profit, entrepreneur, CXO or other entities. Consumers input data, using an online form, as to their technical, business, research expertise and other fields of interest. Key words and phrases in the technology-based idea form are matched to the idea consumers' form and an introduction is made via a computer generated output. The process is then allowed to proceed down a series or pre-structured steps in the commercialization process to establish a viable link between a technology-based idea and a product developer/consumer. These pre-set contracts are loaded into the computer system and are triggered as both parties agree to move to next step. The entire process is manually aided by a series of external training and customer service modules that are available to provide hands-on training and discussion. Technology matches can take the form of a traditional fee based license, a start-up company, an executive in residence or member of a closed reviewer network.

A key embodiment of the technology-based idea/IP assessment process is the semi-automated creation of a confidential network of reviewers to contribute to the relevancy analysis of a new technology-based idea or existing intellectual property. When an online technology-based idea form is populated and parsed and the idea generator is established in the computer system, both the technology-based idea's industry fields and the name of the idea generator are traced in a unique contact database that tracks identifying information and color-coded connections of a persons' social and industry network. The idea generator is then matched to existing company sectors and/or research interests and a graphical representation of the idea generators connection strength is produced as shown in Figure ______. Key contacts, reviewers, entrepreneurs and companies are identified and matches are made to pursue the next stage of commercialization. An invitation, via the automated system, is sent out to potential idea consumers and in this case a closed network is identified and formed to further assess a technology-based idea or IP. The closed network would then be sent online forms, evaluations questions and a matrix to evaluate the technology-based idea or IP. Feedback would be provided based on a numerical output and this in combination with the previous relevancy search would be the basis for an overall commercialization score and the genesis for proceeding to the legal protection phase of the process.

When a new technology-based idea has been screened by the system, a closed group of relevant experts and is above the minimum threshold, it proceeds to the service provider aspect of the system. Service providers will complete an online survey qualifying their expertise, human resources, skills, and their ability to conform to set of diligence obligations and contractual policies and procedures. The service providers are validated based on work experience and recommendations from the database of idea consumers. Once a validated service provider enters the system he may view the technologies, business and technology-based ideas that have been matched with their entity but it is up to the idea generator or designated party to select the appropriate service provider and proceed to execute an automate contract. The contracts, procedures and fee structures are pre-set so that maximum return and cost savings are tracked throughout the process. A unique aspect of the invention is the

Idea generators may log into this secure database and system at any time to review the status, phase, financials and next steps in the ultimate monetization of their technology-based idea, business or IP. The idea generator may track key consumers, tag them, and suggest new consumers based on the idea generators ability to search through the idea consumer database at any time. This embodiment allows for real time access, input and regular communication through the most difficult part of the commercialization process: the marketing and financial structuring phase. Idea consumers can be tagged or designated as a commercialization party of interest and are automatically sent a non-confidential summary of the tagged business or technology. Both idea generators and consumers have the ability to log into a secure database and search, update and run queries for new and existing ideas and IP.

The invention allows for unique marketing tool to attract potential parties of interest. When a technology-based idea has been entered and screened in the system database, a query is run by a user of the system to designate companies of interest. When a company of interest is identified a visual graph is generated showing the companies and key contacts. A targeted query for a specific company or individual may also be executed so that once the individual or company is identified the shortest path to reach that individual or company is generated such that a graphical output is seen that indicates how many individuals separate the user from the desired contact. The shortest path to a potential idea consumer can then be automatically contacted through the computer system and a summary of the technology, IP or company is sent and then the process for completion of a license or start-up is indicated. This embodiment will also identify non-conflicted executive talent to run or start a new company based on a given technology. The Targeted Consumer or CEO is then matched with a technology for the interest of starting a new company. When the idea generator and consumer agree to start a new company the system files the necessary corporate legal documents, by-lays, shareholder agreements, recommends an appropriate capitalization table, and structures a milestone-based path to product development or next steps in the startup process. The computer system surveys and gathers, in a unique database (Venture Bench) a business support, service provider network whereby a service provider such as a web designer, graphic designer, logo specialist, accountant, CPA, manufacturer, prototyping facility, regulatory specialist, etc., can list services and provide those services at set prices to new start-up and existing companies.

The relationship between generator and consumer is formalized through pre structured License agreement that allows for customization based on industry and stage of development for a given technology. A database provides drop-down milestones that should be followed as path toward product development.

Next to the recruitment and matching of a high quality CEO or executive management team, for a start-up company, the capitalization needed to execute on a business or product development plan is the most important step in the success of a company. The computer system has a built in education module that prepares an idea consumer or generator for the fund raising process and ensures that their business has successfully identified an unmet meet, a willing group of ready customers, a market that can support the business and the ability to scale the company and/or manufacturing into a viable business. This Nail-it-Scale it module provides a step by step instructional toll to map out and identify the aforementioned objectives. Through a series of online worksheets, videos and educational seminars a technology-based business idea is secured and funding pitch is prepared and scrutinized. A verification and certification process will be incorporated into the computer based training and users and their technologies or companies will be given a special designation and poof of certification. A user needs to be certified that he has gone through the process for every new technology based start-up in the system that they are involved with or seeking funding.

Specific to this automated system is a series of early stage funds that allow for an idea generator or consumer to send online documents, presentations, business plans, and financials to a computer system that compiles these documents into specific databases based on name recognition and notifies the designated funding managers via email. Funding channels are established based on industry specifications (i.e. medical devices, agriculture, software, energy and others) and users or companies have the ability to log into the system and submit documents at any time. Preferential funding access will be given to those that can show proof of certification that they have been through the Nail-it-Scale process for each company or technology that they are submitting for funding. Online summary forms will be available to download and submit to ensure consistency of format for all idea and companies submitted. Once a technology or company has been verified in the system it will be screened by a trusted group of fund reviewers and pre-screened. If the pre-screening process results in a minimum score, it will be placed in an On-line meeting folder to be reviewed by the investment committee for funding.

A portion of all start-up equity will be held in a secure database pool for trusted reviewers to access and monitor as they wish. Online shares will be held in the reviewers or idea consumers name until such time that a liquidity event occurs and the monetary value is distributed. All company exits, acquisitions, mergers, and sales will be tracked on line for reviewers to access based on a secure log in code.

What is claimed is:

1. A method and computer system to assess technology-based ideas based on the prioritized strength of an idea and the idea's generator in a relative network with said method comprising:
a. Obtaining data of a technology-based idea via a secure data input device to parse and separate out an ideas' specific attributes, features, novelty, art and consumer need;
b. Gathering specific information from the input data to create an automated output of the summary of a technology-based idea that can serve as a marketing tool;
c. Controlling the validity of the data input and providing feedback;
d. Generating a numerical output of a technology-based idea's value and strength against other similar or unrelated technology ideas using networked databases;
e. Surveying individuals, researchers, and business professionals for relevant information;
f. Generating an automated output of recommended reviewers for the technology-based idea;
g. Maintaining a database of technology-based ideas, idea generators and idea consumers.

2. A method according to claim 1 that provides a graphical representation of an idea consumer's strength in their network of expertise.

3. A method according to claim 1 that creates a match between an idea generator, idea consumer, or company with a relevant technology comprising a search that separates out individuals who have conflicts based on a personal survey and prior art.

4. A method according to claim 1 that generates a trusted group of idea consumers in a confidential network to provide feedback, assessment and support for commercialization of a matched or unmatched technology-based idea.

5. A method according to claim 4 that creates an automated incentive system for idea consumers to receive monetary remuneration and points to participate in a long term reward system.

6. A method according to claim 1 that generates a recommended path to commercialization and subsequent steps in the semi-automated process.

7. A system according to claim 1, using a computer, to protect technologies, technology-based ideas and intellectual property such as patents, trademarks, trade secrets, software, source code, patents and copyrights comprising:
a. Surveying service providers to gather expertise and fixed fee structures for online services;
b. Generating an output the matches a technology or technology-based idea with a service provider;
c. Generating a automated contract to establish a strategic relationship between service provider and technology or intellectual property;
d. A computer tracking algorithm that monitors and summarizes legal costs savings based upon an automated analysis of budgets, reimbursements and approved purchases.

8. A method according to claim 1 that results in a lower ranked technology-based idea, patent or an intellectual property (IP) needing an outlet other than a value based license or new start-up company.

9. A method according to claim 8 that creates, provides and maintains a database and channels to donate, auction, trade and pool intellectual property comprising:
a. Generating a computer output of related technologies, technology-based ideas, companies or individuals that have relevance to;
b. Creating a listing service or graphical diagram that targets companies and idea consumers in a network;
c. Conducting on-line transactions for sale, trade or donation to an entity, party, company, non-profit or government.

10. A user interface that allows customizable searches and searching for a technology-based idea matched to an individual or company survey based on the individual or company's needs, technical expertise or business experience.

11. A process according to claim 3 that results in a new start-up company being formed from a technology, technology-based idea or an intellectual property from a network database comprising:
a. The set and creation of a new company by filing, using an automated system, articles of incorporation, and relevant corporate documents;
b. Creating a needs assessment and product development plan for start-ups based on stage of technology, capital needs, industry segment, competition, and executive team;
c. Providing funding for early stage companies by providing access to internal and external funding sources;
d. Aligning all the necessary stakeholders that are required for the success of a start-up company in a trusted network so they are accessible and assigned team objectives;
e. Structuring and negotiating terms for licenses and capitalization based on pre-set templates;
f. Providing a suite of services that are necessary for a start-up to maximize return on investment—venture bench;
g. A corporate exit system that tracks the valuation and monetization of equity and distributes it to shareholders and reviewers involved in the assessment and commercialization of the associated technology or technology-based idea.

12. A business process method according to claim 11 that automates and shortens the path from the generation and protection of a technological-based idea to the creation of a new company.

13. A process according to claim 11 that trains a user in the process of nailing and scaling an idea or a technology-based idea, in which a customer is identified and an unmet need is being met based on the technological-based idea that is being commercialized and validated.

14. A process according to claim 3 that provides management and entrepreneurial talent and matches talent with technology-based idea from a comprehensive talent database that is maintained on internal servers.

15. A method according to claim 7 that creates a compliance system for monitoring licensees and creating automated contracts with service providers.
